(19) United States
(12) Patent Application Publication
(10) Pub. No.: US 2009/0313463 A1
(43) Pub. Date: Dec. 17, 2009

(54) DATA MATCHING USING DATA CLUSTERS

(75) Inventors: Chaoyi Pang, Queensland (AU); Lifang Gu, Australia Capital Territory (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: COMMONWEALTH SCIENTIFIC AND INDUSTRIAL RESEARCH ORGANISATION, Act (AU)

(21) Appl. No.: 12/084,472

(22) PCT Filed: Nov. 1, 2006
(86) PCT No.: PCT/AU2006/001637

§ 371 Date: Feb. 25, 2009

(30) Foreign Application Priority Data
Nov. 1, 2005 (AU) 2005906045

(51) Int. Cl. G06F 12/14; G06F 7/20; G06F 17/30

(52) U.S. Cl. 713/150; 707/2; 707/E17.046

(57) ABSTRACT

An aspect of the present invention provides a method for matching data records held by a plurality of data custodians that relate to a particular entity. One such method comprises the steps of receiving a plurality of clusters of data records from each of the plurality of data custodians (310), comparing related data records received from each of the data custodians (320) and determining whether the related data records relate to the entity based on the result of the comparison (330). The data records in each cluster are representative of a data record held by a respective data custodian. Other aspects of the present invention provide systems and computer program products that embody the methods of the present invention.

### FIELD OF THE INVENTION

The present invention relates to the comparison of data and more particularly to the matching of related data held by multiple data custodians.

### BACKGROUND

Similarity join refers to a methodology for identifying and linking together related data records held in heterogeneous data repositories. The problem of accurately and efficiently identifying related data held in different data repositories is difficult, even when all of the parties or data custodians involved are willing to divulge their data in full. However, when confidentiality constraints apply to certain of the data, the difficulty in performing similarity join is greatly increased. This problem is known as privacy preserving similarity join (PPSJ).

A prime example of an application requiring PPSJ is the integration of health or medical data. For example, it is desirable for independent data custodians to share their medical data for research purposes without revealing sensitive information such as a patient's name and date of birth in accordance with privacy legislation and policies. In most cases, the data held by different data custodians will be diverse to some degree. For example, two hospitals may use slightly different strings to describe the name of a particular patient. Furthermore, typographical errors may be present in the data. In such cases, existing secure multi-party protocols, which are generally based on exact matching, will perform inadequately.

When matching sensitive data held by different data custodians, a method of dealing with privacy constraints imposed on the data is to encrypt any data before it leaves the data custodians. However, this method is only effective if the data is error free and is of exactly the same format as good encryption and/or hashing algorithms are generally unable to maintain the distance between values on account of being non-linear in nature.

The PPSJ problem has been addressed by T. Churches and P. Christen in a paper entitled “Some methods for blindfolded record linkage”, published in BMC Medical Informatics and Decision Making, 4(1):9, 2004. This document proposes a method based on the n-gram similarity comparison. The method disadvantageously creates a data explosion and may be vulnerable to statistical attacks. In a paper entitled “Secure and private sequence comparisons”, published in WPES '03: Proceedings of the 2003 ACM workshop on privacy in the electronic society, pages 39-44, ACM Press, 2003, M. J. Atallah, F. Kerschbaum and W. Du propose a secure protocol for computing the edit-distance on strings located at different data custodians. The protocol, which computes the exact edit distance between two strings, uses a homomorphic (commutative) encryption scheme to achieve minimal necessary information sharing across private data custodians. Disadvantageously, the protocol is extremely slow on account of employing single letter bound encryption with each letter being sent to a third party comparison server.

In light of the foregoing, a need exists to provide improved methods and systems for matching related data held by multiple data custodians whilst maintaining privacy in relation to certain aspects of the data.

A need also exists to provide improved methods and systems for matching data held in heterogeneous databases when the data contains errors or may be approximate in value (i.e., non-exact matching).

### SUMMARY

According to an aspect of the present invention, there is provided a method for matching data records held by a plurality of data custodians that relate to a particular entity. The method comprises the steps of receiving a plurality of clusters of data records from each of the plurality of data custodians, comparing related data records received from each of the data custodians and determining whether the related data records relate to the particular entity based on the result of the comparison. The data records in each cluster are representative of a data record held by a respective data custodian.

Each data record in a cluster may comprise a different data item that is similar to a single data item held by a respective data custodian and an associated measure of similarity between the data record and a data record held by the respective data custodian. The associated measure of similarity may, for example, comprise edit distances, n-grams or any other distance metrics. The related data records typically each comprise a common data item.

The step of comparing related data records may comprise the sub-steps of summing the measures of similarity associated with each of the related data records and determining the minimum of the summed measures of similarities, wherein the minimum comprises a similarity score between the related data records.

The foregoing method may be performed by an independent party. The data items may be encrypted using a secret key that is known to each of the data custodians but that is unknown to the independent party.

According to another aspect of the present invention, there is provided a method for matching data records held by a plurality of data custodians that relate to a particular entity. The method comprises the steps of identifying a cluster of data records that are similar to each data record held by a data custodian and submitting the clusters of data records to an independent party for matching with data records submitted by other data custodians.

The cluster of data records may be identified from a reference table available to each of the plurality of data custodians.

Each of the data records in the clusters may comprise a data item and an associated measure of similarity between the data record and a data record held by a respective data custodian.

The data items may be encrypted using a secret key that is known to each of the data custodians but that is unknown to the independent party.

Another aspect of the present invention provides a computer system for matching data records held by a plurality of data custodians that relate to a particular entity. The computer system comprises a communications interface for transmitting and receiving data, a memory unit for storing data and instructions to be performed by a processing unit and a processing unit coupled to the communications interface and the memory unit. The processing unit is programmed to receive a plurality of clusters of data records from each of the plurality of data custodians, compare related data records received from each of the data custodians and determine whether the related data records relate to the entity based on the result of the comparison. The data records in each cluster are representative of a data record held by a respective data custodian.

Another aspect of the present invention provides a computer system for matching data records held by a plurality of data custodians that relate to a particular entity. The computer system comprises a communications interface for transmitting and receiving data, a memory unit for storing data and instructions to be performed by a processing unit and a processing unit coupled to the communications interface and the memory unit. The processing unit is programmed to identify, for each data record held by the data custodian, a cluster of data records that are similar to a data record held by the data custodian and to submit the clusters of data records to an independent party for matching with data records submitted by other data custodians.

Another aspect of the present invention provides a computer program product comprising a computer readable medium comprising a computer program recorded therein for matching data records held by a plurality of data custodians that relate to a particular entity. The computer program product comprises computer program code for receiving a plurality of clusters of data records from each of the plurality of data custodians, computer program code for comparing related data records received from each of the data custodians and computer program code for determining whether the related data records relate to the entity based on the result of the comparison. The data records in each cluster are representative of a data record held by a respective data custodian.

Another aspect of the present invention provides a computer program product comprising a computer readable medium comprising a computer program recorded therein for matching data records held by a plurality of data custodians that relate to a particular entity. The computer program product comprises computer program code for identifying, for each data record held by the data custodian, a cluster of data records that are similar to a data record held by a data custodian and computer program code for submitting the clusters of data records to an independent party for matching with data records submitted by other data custodians.

### BRIEF DESCRIPTION OF THE DRAWINGS

A small number of embodiments are described hereinafter, by way of example only, with reference to the accompanying drawings in which:

FIG. 1 is block diagram of a system with which embodiments of the present invention may be practised;

FIG. 2 is a flow diagram of a method for sending data representative of data held by a data custodian to an independent party for matching or comparison with similar representative data sent by other data custodians;

FIG. 3 is a flow diagram of a method to match data held by multiple data custodians that relates to a common entity;

FIGS. 4a and 4b illustrate an example of data matching using encrypted data and data clusters in accordance with an embodiment of the present invention; and

FIG. 5 is a schematic block diagram of a computer system with which embodiments of the present invention may be practised.

### DETAILED DESCRIPTION

Embodiments of methods, systems and computer program products are described hereinafter for comparing and/or matching data held by different data custodians that may relate to a particular entity. The data may be held in heterogeneous data repositories. The data comparison enables an independent party or service provider (e.g., linking service) to match data records held by multiple data custodians that relate to a particular entity without identifying the entity to the linking service or to the other data custodians. The embodiments described herein have applicability in the health care business sector, particularly to medical records held by different data custodians that relate to the same patient. However, the present invention is not intended to be limited to this application or sector as embodiments thereof have application in the wider data linkage market. For example, embodiments of the present invention may be applicable to data in the financial and legal business sectors, especially when privacy of data is necessary or desirable.

Embodiments described hereinafter determine whether two or more data records closely match one another or are similar. Certain embodiments require strings to be compared for similarity, such as patient names in medical data records.

One measure of similarity employed in relation to strings is that of edit distance, which comprises the number of character deletions, insertions or substitutions required to transform from one string to another. For example, consider two strings S1 and S2:

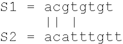

The edit distance between strings S1 and S2=dis(S1,S2)=4

Edit distance advantageously describes the difference between strings precisely but is computationally expensive.

Another measure of similarity employed in relation to strings is that of n-grams. For example, consider two strings S1 and S2:

$$S 1 = BABEL \{ \$ B , BA , AB , BE , EL , L \$ \}$$

$$S 2 = ABDEL \{ \$ A , AB , BD , DE , EL , L \$ \}$$

$$Thus , \\ \begin{matrix}sim ( S 1 , S 2 ) = \vert S 1 ⋂ S 2 \vert / \vert S 1 U S 2 \vert \\ = \vert \{ AB , EL , L \$ \} \vert / \vert \{ \$ A , \$ B , AB , BA , BD , DE , EL , L \$ \} \vert \\ = 3 / 8\end{matrix}$$

N-grams are not as computationally expensive as edit distance and provide a good approximation to edit distance.

The skilled reader will, however, appreciate that edit distance, n-grams, or any other measure of similarity such as Soundex, Metaphone, etc. may be practiced in embodiments of the present invention.

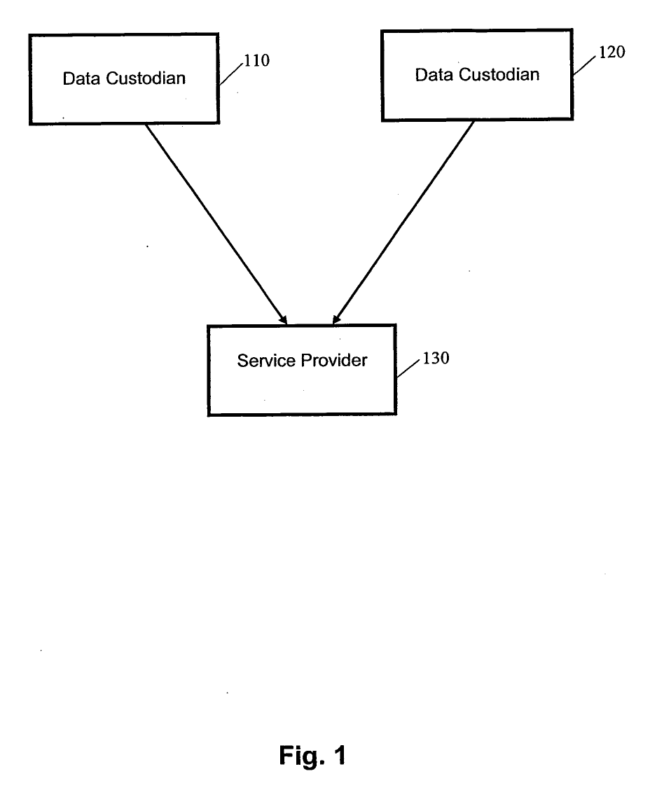

FIG. 1 shows two data custodians (data repositories) 110 and 120 and a service provider 130 capable of identifying matching or linked data held by the data custodians 110 and 120 without the actual data being revealed to the service provider 130. The service provider 130 is typically an independent third party. Although the example illustrated in and described with reference to FIG. 1 includes only two data custodians, it will be obvious to those skilled in the art that embodiments of the present invention may be practiced across more than two data custodians.

The data custodians 110 and 120 each identify a cluster of data records that are similar to or closely match each data record held by the respective data custodian. Two data records are said to closely match if the distance between the data records is less than a predefined amount. The clusters of data records identified by the data custodians 110 and 120, together with respective distances from a respective original data record, are sent to the service provider 130.

The service provider 130 compares and matches related or potentially related data records received from each of the data custodians 110 and 120. The comparison and matching may be performed without the service provider 130 having any knowledge of the entity to which the related data records relate. Furthermore, each of the data custodians 110 and 120 do not receive any data records from the other.

Matching may be based on distance metrics such as the Jaccard-coefficient.

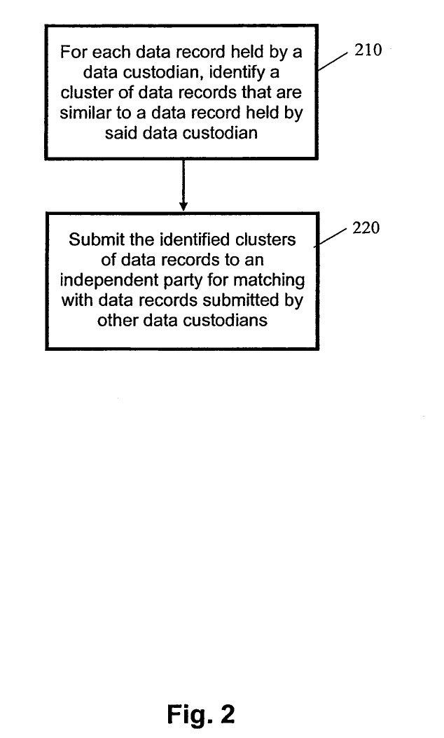

FIG. 2 is a flow diagram of a method to send data representative of data held by a data custodian to an independent party for matching or comparison with similar representative data sent by other data custodians. The method may be practiced by the data custodian.

At step 210, a cluster of data records is identified for each data record held by the data custodian. The data records in a cluster each have a data value close to a data value of the data record held by the data custodian. In certain embodiments, the data values held by the data custodian are compared to data values in a reference table, which is also available to other data custodians. The ‘close’ data values in the reference table may be identified based on a predefined distance to the associated data value held by the data custodian.

The data values in the cluster are optionally encrypted. Encryption may be performed using a keyed hash, for which the key is known to the multiple data custodians but not to the independent party that performs the comparison or matching.

At step 220, the data values (which may be encrypted) are sent along with associated distances from their respective data value held by the data custodian to the independent party for comparison or matching.

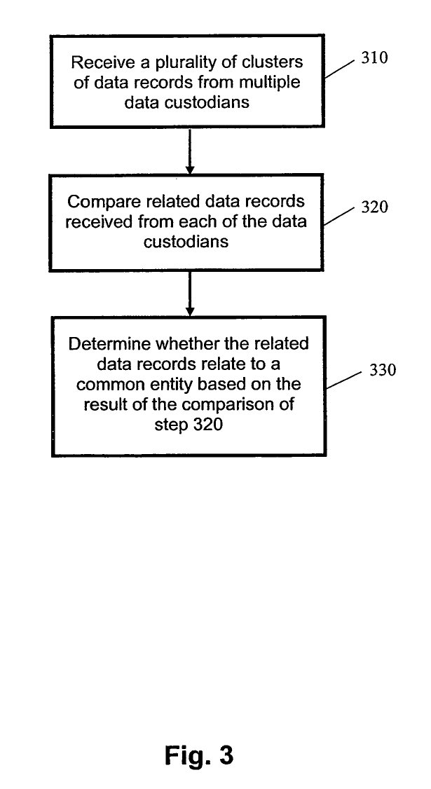

FIG. 3 is a flow diagram of a method to match information held by multiple data custodians that relates to a particular entity. The method may be practiced by an independent party such as a linking service.

At step 310, a plurality of clusters of data records are received from each of a plurality of data custodians. Each data record in a cluster is representative of a data record held by the respective data custodian that relates to an entity (e.g., a medical patient record).

Related data records received from the data custodians are compared at step 320. Related data records are identified by matching data items or values in the data records. As the data custodians each use the same reference table to select the data values in the clusters, the related data records will typically match exactly. The data items or values in the data records received from the data custodians may be encrypted for data security reasons using a secret key. As each of the data custodians use the same private key to encrypt the data items or values, the data items or values will still match exactly.

At step 330, a determination is made whether the related data records compared in step 320 relate to the same common entity. If so, the related data records constitute a match.

By way of example with reference to FIG. 1, assume that the data custodian 110 holds multiple data records comprising a sole attribute (value) denoted by s. For each data value held by the data custodian 110, the data custodian 110:
identifies a list of data values from the reference table that are within a predefined distance of the respective data value held by data custodian 110,
encrypts each data value identified in the reference table using a keyed hash for which the key is known only to data custodians 110 and 120 and not to service provider 130, and
sends the encrypted data values together with associated distances to the service provider 130.

For example, data custodian 110 may send the following information to the service provider 130 for each data record held:

(idᵢ,((enc(t₁), d(s,t₁)), (enc(t₂), d(s,t₂)), . . . , (enc(tₖ), d(s,tₖ))))

where:
s is a data value held by data custodian 110,
idᵢ is a random identifier for s,
enc is an encryption function (e.g., a keyed hash),
t₁, t₂, . . . , tₖ are data values from the reference table that are closest to s, and
d(s, t) is the distance between s and t.

Similarly, assume that the data custodian 120 holds multiple data records comprising a sole attribute (value) denoted by r. Data custodian 120 may send the following information to the service provider 130 for each data record held:

(idᵢ,((enc(t₁),d(r,t₁)), (enc(t₂),d(r,t₂)), . . . , (enc(tₖ),d(r,tₖ))))

where:
r is a data value held by data custodian 110,
idᵢ is a random identifier for r,
enc is an encryption function (e.g., a keyed hash),
t₁, t₂, . . . , tₖ are data values from the reference table that are closest to r, and
d(r, t) is the distance between r and t.

The service provider 130 receives the information from data custodians 110 and 120 and determines the intersection of the two regions for each value pair from data custodians 110 and 120, based on corresponding encrypted values from the reference table. The service provider 130 then calculates the distance between each value pair (s, r). The minimum of the distances may be used as a similarity score between the value pair (s, r):

min{(d(s,t₁)+d(r,t₁)), . . . , (d(s,tᵢ)+d(r,tᵢ)), . . . , (d(s,tₘ)+d(r,tₘ))}

where:
d(s, t) is the distance between s and t,
d(r, t) is the distance between r and t,
m is the number of intersection values for the value pair s and r, and
tᵢ is an encrypted value from the reference table.

The foregoing method is predicated on the triangle inequality formula:

d(s,r)≦d(s,t₁)+d(r,t₁)

and enables a decision to be made regarding how well the two values compare.

Alternatively, the similarity measure may be based on other metrics such as the Jaccard-coefficient.

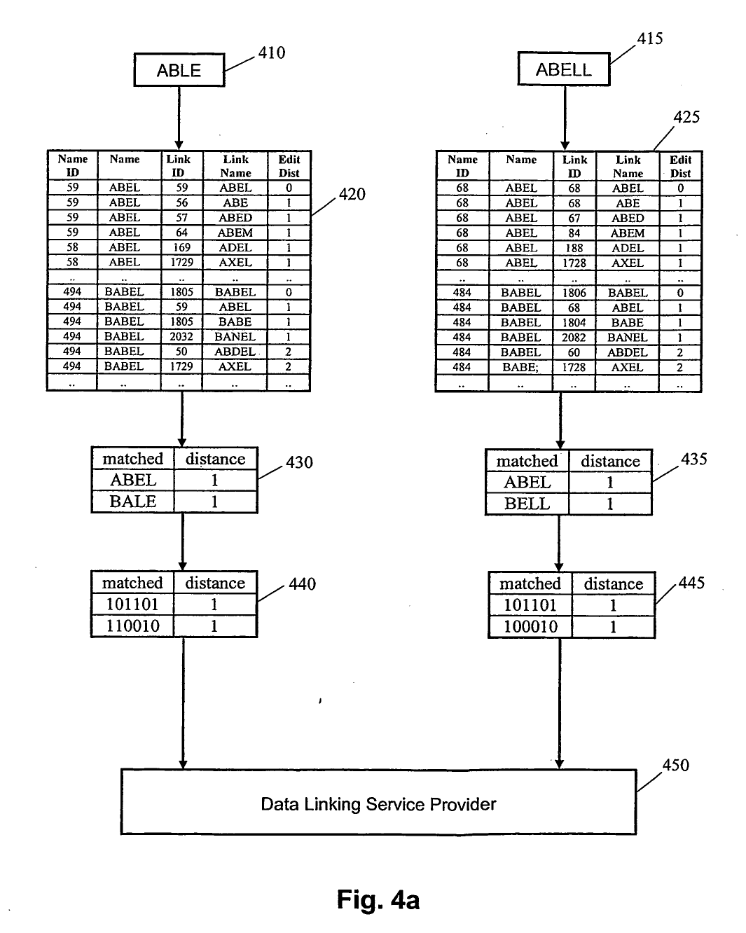

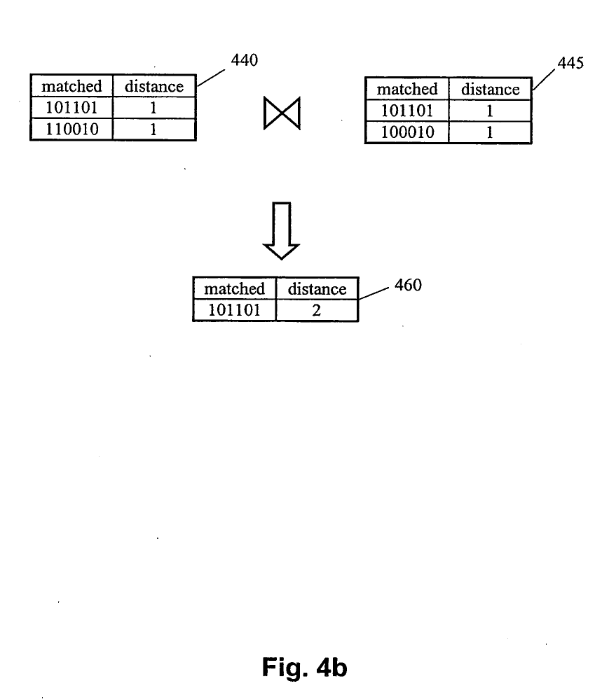

FIGS. 4a and 4b illustrate an example of data matching using encrypted data and data clusters in accordance with an embodiment of the present invention. The functions shown in FIG. 4a are performed by the various data custodians and the functions shown in FIG. 4b are performed by an independent party (e.g., a data linking service provider).

Referring to FIG. 4a, a data custodian A (not shown) holds the name ‘ABLE’ 410 and a data custodian B (not shown) holds the name ‘ABELL’ 415.

At data custodian A, the name ‘ABLE’ 410 is compared with the names contained in a reference table, of which an extract 420 is shown in FIG. 4a. The result of the comparison is a matched cluster of linkNames and associated distances {(‘ABEL’, 1), (‘BALE’, 1)}, as shown in table 430. Each name in the matched cluster of linkNames 430 is encrypted as shown in table 440:
encrypt(‘ABEL’)=101101
encrypt(‘BALE’)=110010

Encryption is performed using a private key that is also known and used by data custodian B for the same purpose.

Data custodian A sends the cluster of data records {(101101,1), (110010,1)} 440 to the linking service provider 450.

At data custodian B, the name ‘ABELL’ 415 is compared with the names contained in a reference table, of which an extract 425 is shown in FIG. 4a. The result of the comparison is a matched cluster of linkNames and associated distances {(‘ABEL’, 1), (‘BELL’, 1)}, as shown in table 435. Each name in the matched cluster of linknames 435 is encrypted as shown in table 445:
encrypt(‘ABEL’)=101101
encrypt(‘BELL’)=100010

Encryption is performed using a private key that is also known to and used by data custodian A for the same purpose.

Data custodian B sends the cluster of data records {(101101,1), (100010,1)} 445 to the data linking service provider 450.

The data records sent to the data linking service provider 450 may be ‘blurred’ and/or relative distances may be used in place of actual distances for improved security and/or privacy.

The data may be blurred by generating and adding new tuples having linkNames that do not match exactly with the linkNames of other tuples at the data linking service provider. Use of relative distances in place of actual distances may also or alternatively be employed to provide improved security and/or privacy.

Consider an example wherein a data custodian holds the data set A={(c1,1), (c2,1), (c3,2), (c4,2), (c5,3)} and the data set sent to the data linking service provider comprises A′={(c0,0), (c1,0), (c2,0), (c3,1), (c4,1), (c5,2)}. (c0,0) is a new tuple with c0 selected not to match any other tuples at the data linking service provider. For example, c0 might comprise the hash value of CustodianID+nameID(‘ABLE’) and be identical to the processed data. Assuming that A represents a set of name-distance pairs in the reference table for custodian data cc, the distance between cc and c1 is 1, the distance between cc and c3 is 2, the distance between cc and c4 is 2, etc. The distances in data set A represent actual distances whereas the distances in data set A′ sent to the data linking service provider are relative to those actual distances. In the above example, the relative distances in data set A′ are generated from the actual distances in data set A by subtraction of a fixed offset of 1 (e.g., (c1,1)->(c1,0). Each data custodian can select a fixed offset that is independent to that selected by other data custodians. More generally, the relative distances may be generated as follows:
RelativeDistance=ActualDistance−constant_number; or
RelativeDistance=ActualDistance+constant_number.

Referring to FIG. 4b, after receiving the data clusters 440 and 445, the data linking service provider 450 finds the intersection of encrypted names from the two data clusters 440 and 445 and sums the distances associated with each name in the intersection. This produces the data record {101101,2}, as shown in table 460, which is representative of the name ‘ABEL’.

In the foregoing example, the two names ‘ABLE’ and ‘ABELL’ match the reference data “ABEL”. That is:

dist(idA₁, idB₁)≦2

where: idA₁ is the ID of ‘ABLE’ in data custodian A, and
idB₁ is the ID of ‘ABELL’ in data custodian B.

One method of determining matching is to determine whether there exists a idBⱼ which is different from idB₁, such that:

dist(idA₁, idBⱼ)≦1

If so, it may be concluded that idA₁ and idB₁ (‘ABLE’ AND ‘ABELL’) do NOT match. Otherwise, it may be taken that ‘ABLE’ AND ‘ABELL’ match.

In certain embodiments of the present invention, a cluster of matched tuples is sent to the linking service by each participating data custodian. The tuples are generated by the data custodians for each data record held by the respective data custodians using a common reference table available to each of the data custodians. The reference table comprises a standard set of data records that are specific to the domain of the data being matched. For example, the reference table may comprise a set of name strings for a medical patient record database. In this case, the tuples comprise names in the reference table that are ‘similar’ to the names of patients whose medical records are held by the data custodians. ‘Similar’, in this instance, is defined to mean that the actual name of the patient held by a data custodian and a corresponding name identified in the reference table are within a defined threshold for an adopted distance metric.

An auxiliary relation may optionally be used to accelerate the process of identifying similar names, which involves maintaining a cache of ‘similar’ names for the names in the reference table.

Another useful technique for approximate string matching is to initially identify possible candidates using a fast algorithm and subsequently confirm the similarity of each candidate using a slower but more precise algorithm. Thus, a large matching space may be delimited by firstly pruning off data that is unlikely to be similar. To meet privacy requirements, the identifying data in the tuples may be encrypted prior to being sent to the linking service.

Upon receipt, the linking service compares the clusters of matching tuples provided by the participating data custodians by finding the intersection of the encrypted values in the tuples. The minimum of the sum of the distances for each tuple having the same encrypted value in the intersection provides a similarity score for the related data records and enables a decision to be made about whether the related data records match. For example, if the similarity score is below a defined threshold, the related data records are determined to constitute a match. The defined threshold may be selected based on the data properties.

The methods, systems and computer program products described herein are scalable, in that they may be applied to a large number of data custodians. As the number of data custodians and/or data records increases, the likelihood of the data linking service identifying multiple possible matches will increase. In such cases, the data linking service provider may also rely on additional information to determine the closest match. For example, first names or dates of birth of medical patients may additionally be submitted to the data linking service provider by the data custodians for matching. Where privacy is necessary or desirable, the additional information may be encrypted before submission to the data linking service provider. Matching of such additional information should not require decryption at the data linking service provider.

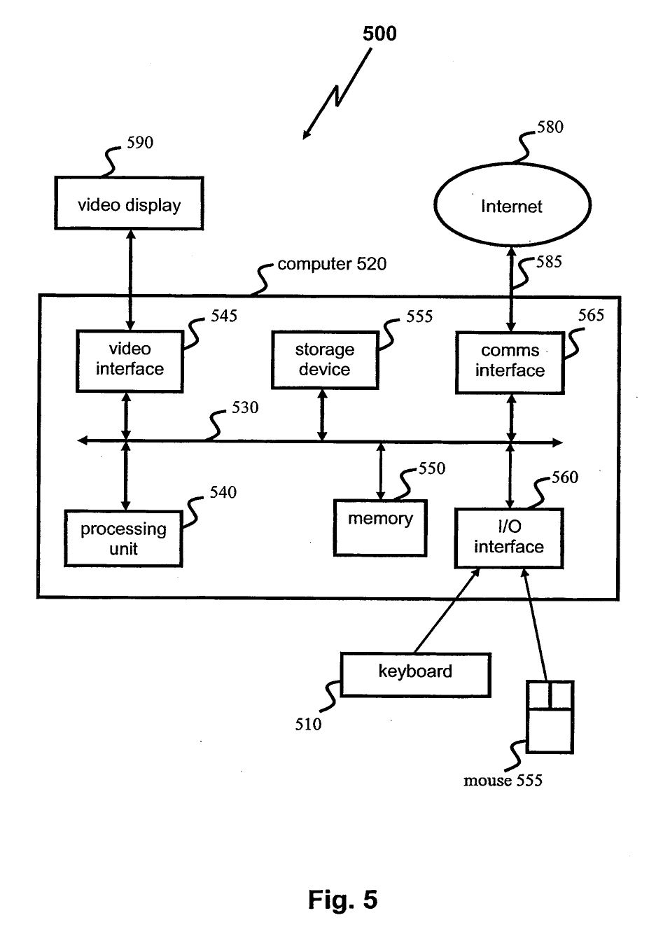

FIG. 5 shows a schematic block diagram of a computer system 500 that can be used to practice the methods described herein. More specifically, the computer system 500 is provided for executing computer software that is programmed to assist in performing methods for comparing and/or matching data held by multiple data custodians. The computer software executes under an operating system such as MS Windows 2000, MS Windows XP™ or Linux™ installed on the computer system 500.

The computer software involves a set of programmed logic instructions that may be executed by the computer system 500 for instructing the computer system 500 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 500 comprise: a computer 520, input devices 510, 515 and a video display 590. The computer 520 comprises: a processing unit 540, a memory unit 550, an input/output (I/O) interface 560, a communications interface 565, a video interface 545, and a storage device 555. The computer 520 may comprise more than one of any of the foregoing units, interfaces, and devices.

The processing unit 540 may comprise one or more processors that execute the operating system and the computer software executing under the operating system. The memory unit 550 may comprise random access memory (RAM), read-only memory (ROM), flash memory and/or any other type of memory known in the art for use under direction of the processing unit 540.

The video interface 545 is connected to the video display 590 and provides video signals for display on the video display 590. User input to operate the computer 520 is provided via the input devices 510 and 515, comprising a keyboard and a mouse, respectively. The storage device 555 may comprise a disk drive or any other suitable non-volatile storage medium.

Each of the components of the computer 520 is connected to a bus 530 that comprises data, address, and control buses, to allow the components to communicate with each other via the bus 530.

The computer system 500 may be connected to one or more other similar computers via the communications interface 565 using a communication channel 585 to a network 580, represented as the Internet.

The computer software program may be provided as a computer program product, and recorded on a portable storage medium. In this case, the computer software program is accessible by the computer system 500 from the storage device 555. Alternatively, the computer software may be accessible directly from the network 580 by the computer 520. In either case, a user can interact with the computer system 500 using the keyboard 510 and mouse 515 to operate the programmed computer software executing on the computer 520.

The computer system 500 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practice the methods and computer program products described hereinbefore.

Embodiments of methods, systems and computer program products have been described hereinbefore for comparing and/or matching data held by different data custodians that may relate to a particular entity.

Use of a public (i.e., available to all participating data custodians) reference table or relation feature, as described herein in certain embodiments, advantageously enables computationally expensive similarity comparisons to be made at the data custodians rather than at the data linking service provider. The matched tuples are obtained through carrying out a grouped or aggregated equal join operation at the data linking service provider, rather than a similarity join operation. This simplifies the overall computation and the transfer of data between the data custodians and the data linking service provider.

Another advantage of certain embodiments described herein is that encrypted reference data from the reference table is sent to the data linking service provider together with associated distance values. More specifically, encrypted custodian data is not directly sent to the data linking service provider. This improves data privacy as the actual data does not leave the data custodian, even in an encrypted form, and is thus less available to other parties.

Yet another advantage of certain embodiments described herein is the feature of the ‘closest’ neighborhood auxiliary relation of the reference table: This feature is used to extract matching items by exploring smaller neighborhoods of those matching items. Alternatively, a fast comparison algorithm may be initially used to find potential matched items first. Edit-distance and/or auxiliary relation may subsequently be used to refine the search.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

1. A method for matching data records held by a plurality of data custodians that relate to a particular entity, said method comprising the steps of: receiving a plurality of clusters of data records from each of said plurality of data custodians, wherein the data records in each said cluster are representative of a data record held by a respective data custodian; comparing related data records received from each of said data custodians; and determining whether said related data records relate to said entity based on the result of said comparison.

2. The method of claim 1, wherein the data records in each of said plurality of clusters of data records each comprise a different data item, each said different data item similar to a single data item held by a respective data custodian.

3. The method of claim 1, wherein said related data records each comprise a common data item.

4. The method of claim 1, wherein each of said data records received from said plurality of data custodians comprises a data item and an associated measure of similarity between said data record and a data record held by a respective data custodian.

5. The method of claim 4, wherein said associated measure of similarity comprises an edit distance.

6. The method of claim 4, wherein said associated measure of similarity comprises an n-gram.

7. The method of claim 5, wherein said step of comparing related data records comprises the sub-steps of: summing the edit distances associated with each of said related data records; and determining the minimum of said summed edit distances.

8. The method of claim 1, wherein said method is performed by a party independent to said data custodians.

9. The method of claim 8, wherein said data items are encrypted using a secret key that is known to each of said data custodians but that is unknown to said independent party.

10. A method for matching data records held by a plurality of data custodians that relate to a particular entity, said method comprising the steps of: for each data record held by a data custodian, identifying a cluster of data records that are similar to a data record held by the data custodian; and submitting said clusters of data records to an independent party for matching with data records submitted by other data custodians.

11. The method of claim 10, wherein said cluster of data records are identified from a reference table available to each of said plurality of data custodians.

12. The method of claim 10, wherein each of said data records in said clusters comprises a data item and an associated measure of similarity between said data record and a data record held by a respective data custodian.

13. The method of claim 12, wherein said data items are encrypted using a secret key that is known to each of said data custodians but that is unknown to said independent party.

14. The method of claim 12, wherein said associated measure of similarity comprises an edit distance.

15. The method of claim 12, wherein said associated measure of similarity comprises an n-gram.

16. A computer system for matching data records held by a plurality of data 5 custodians that relate to a particular entity, comprising: a communications interface for transmitting and receiving data; a memory unit for storing data and instructions to be performed by a processing unit; and a processing unit coupled to said communications interface and said memory Q unit, said processing unit programmed to: receive a plurality of clusters of data records from each of said plurality of data custodians, wherein the data records in each said cluster are representative of a data record held by a respective data custodian; compare related data records received from each of said data custodians; and s determine whether said related data records relate to said entity based on the result of said comparison.

17. The computer system of claim 16, wherein the data records in each of said plurality of clusters of data records each comprise a different data item, each said Q different data item similar to a single data item held by a respective data custodian.

18. The computer system of claim 16, wherein said related data records each comprise a common data item.

19. The computer system of claim 16, wherein each of said data records received from said plurality of data custodians comprises a data item and an associated measure of similarity between said data record and a data record held by a respective data custodian.

20. The computer system of claim 19, wherein said associated measure of similarity comprises an edit distance.

21. The computer system of claim 19, wherein said associated measure of similarity comprises an n-gram.

22. The computer system of claim 20, wherein said processing unit is further programmed to: sum the edit distances associated with each of said related data records; and determine the minimum of said summed edit distances.

23. The computer system of claim 16, wherein said computer system is operated by a party independent to said data custodians.

24. The computer system of claim 23, wherein said data items are encrypted using a secret key that is known to each of said data custodians but that is unknown to said s independent party.

25. A computer system for matching data records held by a plurality of data custodians that relate to a particular entity, said computer system comprising: a communications interface for transmitting and receiving data; 0 a memory unit for storing data and instructions to be performed by a processing unit; and a processing unit coupled to said communications interface and said memory unit, said processing unit programmed to: for each data record held by a data custodian, identify a cluster of data records 5 that are similar to a data record held by the data custodian; and submit said clusters of data records to an independent party for matching with data records submitted by other data custodians.

26. The computer system of claim 25, wherein said cluster of data records are o identified from a reference table available to each of said plurality of data custodians.

27. The computer system of claim 25, wherein each of said data records in said clusters comprises a data item and an associated measure of similarity between said data record and a data record held by a respective data custodian.

28. The computer system of claim 27, wherein said processing unit is further programmed to encrypt said data items using a secret key that is known to each of said data custodians but that is unknown to said independent party.

29. The computer system of claim 27, wherein said associated measure of similarity comprises an edit distance.

30. The computer system of claim 27, wherein said associated measure of similarity comprises an n-gram.

31. A computer program product comprising a computer readable medium comprising a computer program recorded therein for matching data records held by a plurality of data custodians that relate to a particular entity, said computer program product comprising: computer program code for receiving a plurality of clusters of data records from each of said plurality of data custodians, wherein the data records in each said cluster are representative of a data record held by a respective data custodian; computer program code for comparing related data records received from each of said data custodians; and computer program code for determining whether said related data records relate to said entity based on the result of said comparison.

32. The computer program product of claim 31, wherein the data records in each of said plurality of clusters of data records each comprise a different data item, each said different data item similar to a single data item held by a respective data custodian.

33. The computer program product of claim 31, wherein said related data records each comprise a common data item.

34. The computer program product of claim 31, wherein each of said data records received from said plurality of data custodians comprises a data item and an associated measure of similarity between said data record and a data record held by a respective data custodian.

35. The computer program product of claim 34, wherein said associated measure of similarity comprises an edit distance.

36. The computer program product of claim 34, wherein said associated measure of similarity comprises an n-gram.

37. The computer program product of claim 35, wherein said computer program code for comparing related data records comprises: computer program code for summing the edit distances associated with each of said related data records; and computer program code for determining the minimum of said summed edit distances.

38. The computer program product of claim 31, wherein said computer program product is executed by a party independent to said data custodians.

39. The computer program product of claim 38, further comprising computer program code for encrypting said data items using a secret key that is known to each of said data custodians but that is unknown to said independent party.

40. A computer program product comprising a computer readable medium comprising a computer program recorded therein for matching data records held by a plurality of data custodians that relate to a particular entity, said computer program product comprising: computer program code for identifying a cluster of data records that are similar to a data record held by a data custodian, for each data record held by the data custodian; and computer program code for submitting said clusters of data records to an independent party for matching with data records submitted by other data custodians.

41. The computer program product of claim 40, wherein said cluster of data records are identified from a reference table available to each of said plurality of data custodians.

42. The computer program product of claim 40, wherein each of said data records in said clusters comprises a data item and an associated measure of similarity between said data record and a data record held by a respective data custodian.

43. The computer program product of claim 42, further comprising computer program code for encrypting said data items using a secret key that is known to each of said data custodians but that is unknown to said independent party.

44. The computer program product of claim 42, wherein said associated measure of similarity comprises an edit distance.

45. The computer program product of claim 42, wherein said associated measure of similarity comprises an n-gram.
